(19) United States
(12) Patent Application Publication
(10) Pub. No.: US 2007/0114784 A1
(43) Pub. Date: May 24, 2007

(54) Multi-ply automated mail advertising piece

(75) Inventor: John J. Martin, Louisville, KY (US)

Correspondence Address: JAMES C. EAVES JR.;GREENEBAUM DOLL & MCDONALD PLLC, 3500 NATIONAL CITY TOWER, 101 SOUTH FIFTH STREET, LOUISVILLE, KY, 40202, US

(73) Assignee: Crane Productions, Inc.

(21) Appl. No.: 11/589,554

(22) Filed: Oct. 30, 2006

Related U.S. Application Data
(60) Provisional application No. 60/731,535, filed on Oct. 28, 2005.

(51) Int. Cl. B42D 15/00

(52) U.S. Cl. 283/56

(57) ABSTRACT

The present invention is a multi-ply automated mail advertising piece. The multiple pages of the advertising piece are adhered at a lead edge with a permanent glue to contribute to the structural integrity of the advertising piece. The multiple pages are further preferably adhered to each other with nonpermanent glue spots to facilitate the separation of pages. Multiple separable pages provide for more advertising and coupon space, without the requirement that optional perforations align for each page.

This application claims the benefit of U.S. provisional patent application Ser. No. 60/731,535, filed on Oct. 28, 2005, for a multi-ply automated mail advertising piece, incorporated herein by reference.

### BACKGROUND OF THE INVENTION

1. Field of the Invention

The present invention relates to a advertising materials which are mailable directly to consumers. More particularly, the present invention relates to a multi-ply automated mail advertising piece.

2. Description of the Prior Art

The Applicant of this application is the inventor of U.S. Pat. No. 5,458,282 for a card having magnetic sheet secured to a surface; of U.S. Pat. No. 5,868,498 for a magnetic pocket card; and of other patents related to mailable advertising pieces and envelopes or frames having magnets attached.

### SUMMARY OF THE INVENTION

The present invention relates to a multi-ply automated mail advertising piece having a permanently glued lead edge area, the piece having enough thickness and stability so that it moves through United States Postal Service (“USPS”) automated mail processing machines without jamming. The multi-ply automated mail advertising piece may have a magnet for display to a metallic surface or a repositionable adhesive for adherence to a nonmetallic surface. Nonpermanent glue preferably adheres each page to its adjacent page such that each page can be separated from the other, except at the lead edge.

More specifically, the preferred embodiment of the present invention is for a multi-ply advertising piece, comprising: a first page having a first planar surface and a second planar surface; a second page having a third planar surface and a fourth planar surface; the second planar surface and third planar surface having a first glue located in a permanent adhesion area proximate a leading edge of the advertising piece, the advertising piece having an opposite edge and a left side and a right side; means for attachment affixed to the fourth planar surface at a location near the leading edge; and, a second glue located between the second planar surface and the third planar surface along the left side and right side of the advertising piece. The means for attachment can be, for example, magnetic or a repositional adhesive having a removable liner thereover.

### BRIEF DESCRIPTION OF THE DRAWINGS

A better understanding of the present invention will be had upon reference to the following description in conjunction with the accompanying drawings, wherein:

FIG. 1a shows the first planar surface of the first page of a first embodiment of the present invention;

FIG. 1b shows a working example of FIG. 1a;

FIG. 2a shows the second planar surface of the first page of the first embodiment of the present invention;

FIG. 2b shows a working example of FIG. 2a;

FIG. 3a shows the third planar surface of the second page of the first embodiment of the present invention;

FIG. 3b shows a working example of FIG. 3a;

FIG. 4a shows the fourth planar surface of the second page of the first embodiment of the present invention;

FIG. 4b shows a working example of FIG. 4a;

FIG. 5 shows the first planar surface of the first page and a portion of the third planar surface of the second page of a second embodiment of the instant invention;

FIG. 6 shows the first planar surface of the first page and a portion of the third planar surface of the second page in a third embodiment of the instant invention;

FIG. 7 shows the first planar surface of the first page and a portion of the third planar surface of the second page in a fourth embodiment of the instant invention;

FIG. 8 shows the first planar surface of the first page and a portion of the third planar surface of the second page and a portion of a middle page in a fifth embodiment of the instant invention;

FIG. 9 shows a first planar surface having a pocket insert in a sixth embodiment of the instant invention;

FIG. 10 shows a first planar surface and a portion of the third planar surface of the second page having an inside pocket formed by an accordion fold in a seventh embodiment of the instant invention;

FIG. 11 shows a first planar surface, a portion of the third planar surface of the second page, and a series of coupons positioned between the second planar surface and the third planar surface in an eighth embodiment of the invention; and

FIG. 12 shows the second planar surface and the third planar surface in an “open” position in the eighth embodiment of the invention.

FIG. 13 shows a ninth embodiment of an advertising piece where the first page includes a pocket insert near the leading edge.

### DETAILED DESCRIPTION OF THE PREFERRED EMBODIMENT

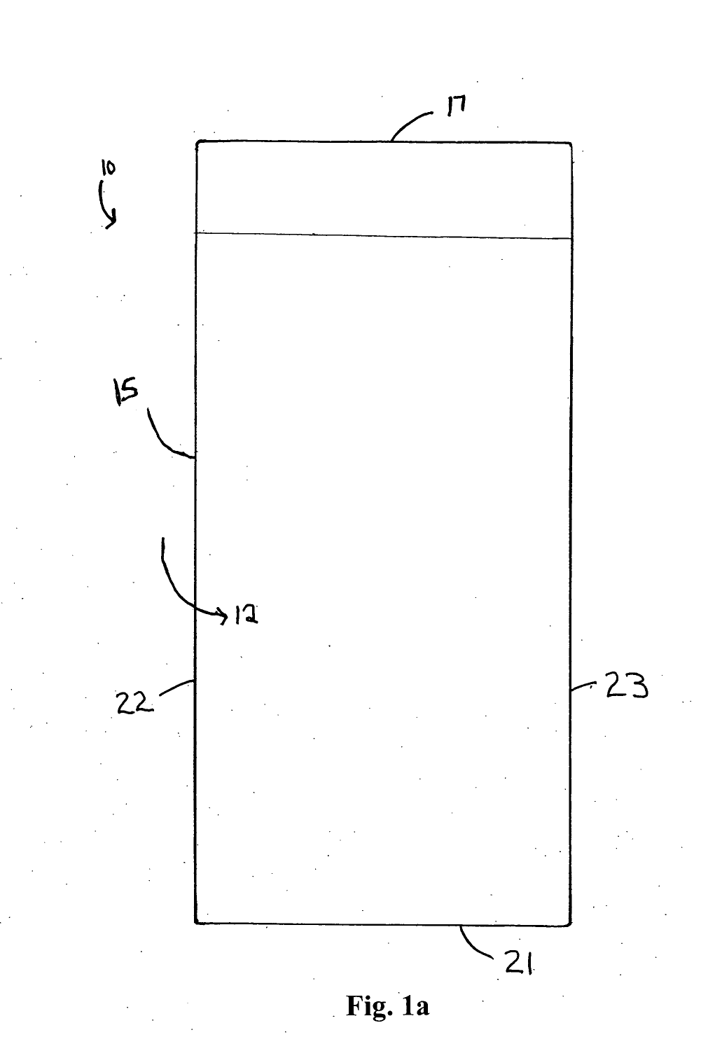

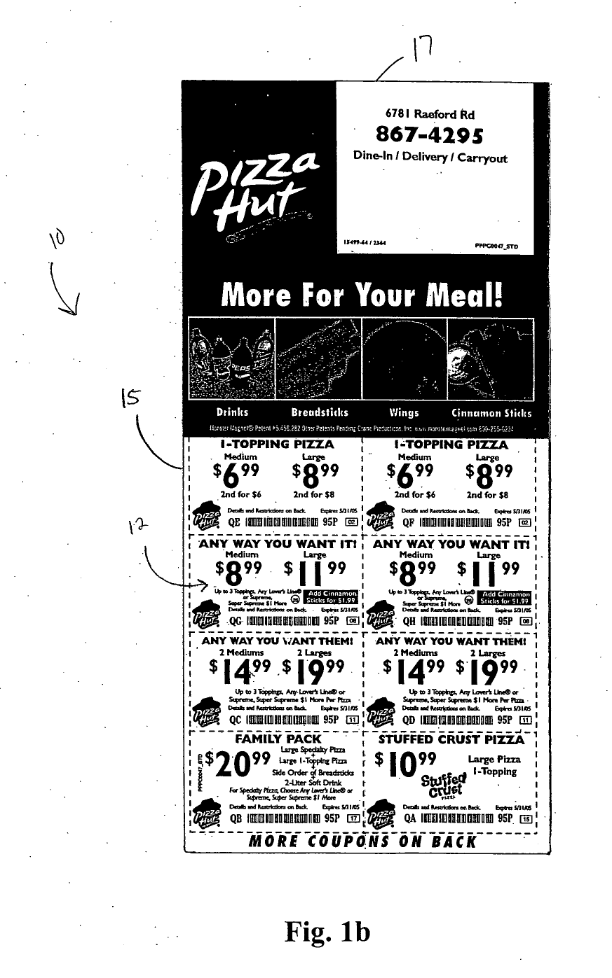

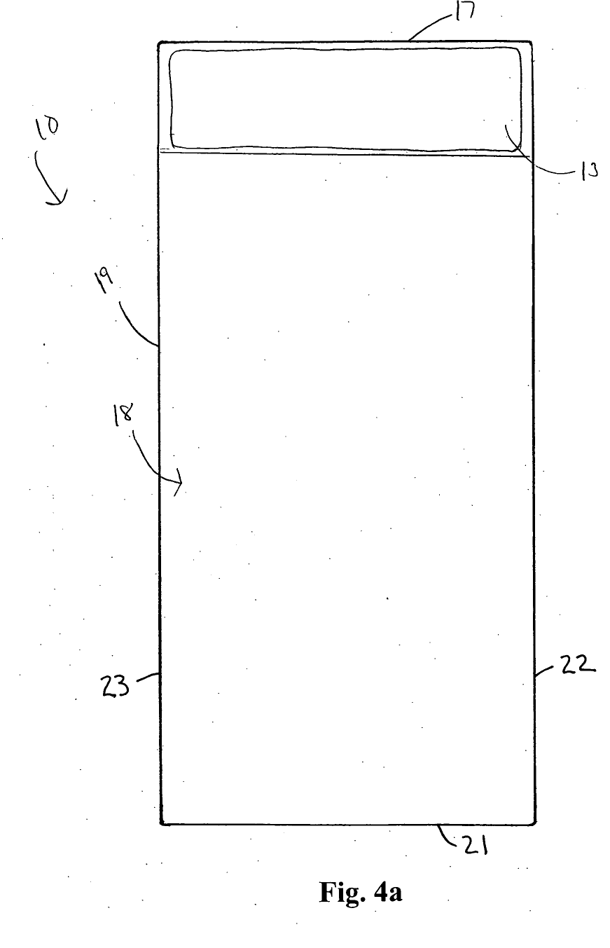

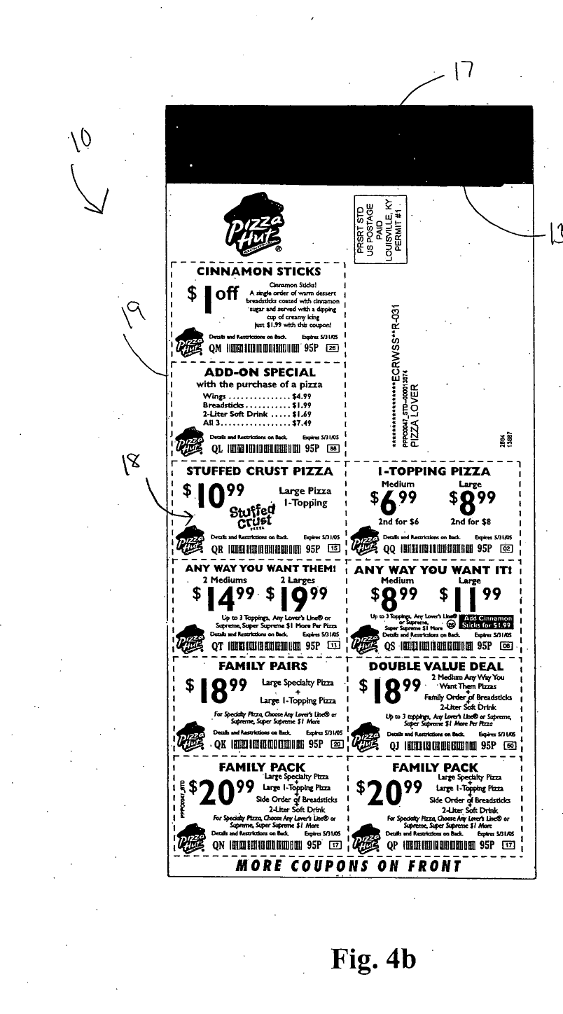

With reference to Figures la, 2a, 3a, and 4a, there is shown a multi-ply automated mail advertising piece 10 of the instant invention. Respective examples are shown in FIGS. 1b, 2b, 3b, and 4b. In this embodiment 10, the advertising piece 10 is formed of a first planar surface 12, a second planar surface 14, a third planar surface 16, and a fourth planar surface 18. The first planar surface 12 and the second planar surface 14 comprise a first page 15. The third planar surface 16 and the fourth planar surface 18 comprise a second page 19. The advertising piece 10 is comprised of a plurality of pages, such that the combined thickness of the pages preferably sums to the equivalent of 9-point stock. The size of the multi-ply automated mail advertising piece 10 is about 5¼ inches×10¾ inches, although the dimensions can vary as long as the size is appropriate for USPS mail processing machines. The second planar surface 14 of the first page 15 and the third planar surface 16 of the second page 19 are permanently adhered to each other in an adhesion area 11 at the lead edge 17 of the advertising piece 10. The lead edge 17 leads the advertising piece 10 as it is processed through the USPS machines. The adhesion area 11 is preferably comprised of about a one inch area of permanent (i.e., solid) glue running from the lead edge 17 toward the opposite edge 21 and preferably from left side 22 to right side 23. The adhesion area provides stability of the lead edge 17 for feeding into and processing through the USPS machines. The proper application of permanent glue at the adhesion area 11 will maintain the integrity of multiple pages through the USPS mailing process. FIGS. 1a and 4a, which illustrate the first planar surface 12 and the fourth planar surface 18, respectively, display a line traversing the advertising piece 10 near the leading edge 17 to point out the area where the first page 15 and the second page 19 are permanently attached. The permanent adhesion is placed in this area where the first page 15 and the second page 19 are permanently attached at the adhesion area 11 of the second planar surface 14 and the third planar surface 16. Pages 15 and 19 can be separated from each other in the area below the line, as described in more detail below.

A means for attachment 13, such as a thin flexible magnetic sheet material or a repositionable adhesive with removable liner may be affixed to the fourth planar surface 18 of the second page 19 at the adhesion area 11 near the lead edge 17. The magnetic sheet material facilitates the application of the advertising piece 10 to a metallic surface, such as a refrigerator door or metallic bulletin board, and the like, to display the advertising piece 10. The magnet can be of varying sizes (length and width) and positioned anywhere on the piece due to the fact that the permanent glue at the lead edge 17 provides the stability. The magnet may be applied as a label, that is, removed from a liner and applied with a permanent adhesive. Also, instead of application of a magnet label, a long strip of roll magnet can be used with individual magnet pieces cut from the roll to desired size, and adhesively affixed to the advertising piece 10. Alternatively, as a means for attachment, a repositionable adhesive with a removable liner may be used at the adhesion area 11 on the fourth planar surface 18 of the second page 19 so that the advertising piece 10 can be adhered to a non-metallic surface. The permanent glue in the adhesion area 11 allows for mailing with or without a magnet at the lead edge 17.

The thin flexible magnetic sheet material 13 is known and is a vinyl material including magnetic materials dispersed therethrough. Such a sheet of flexible magnetic material can be purchased under the trademark “ULTRAMAG” from FlexMag Industrial, Inc., a Division of Dynacast Co., Marietta, Ohio.

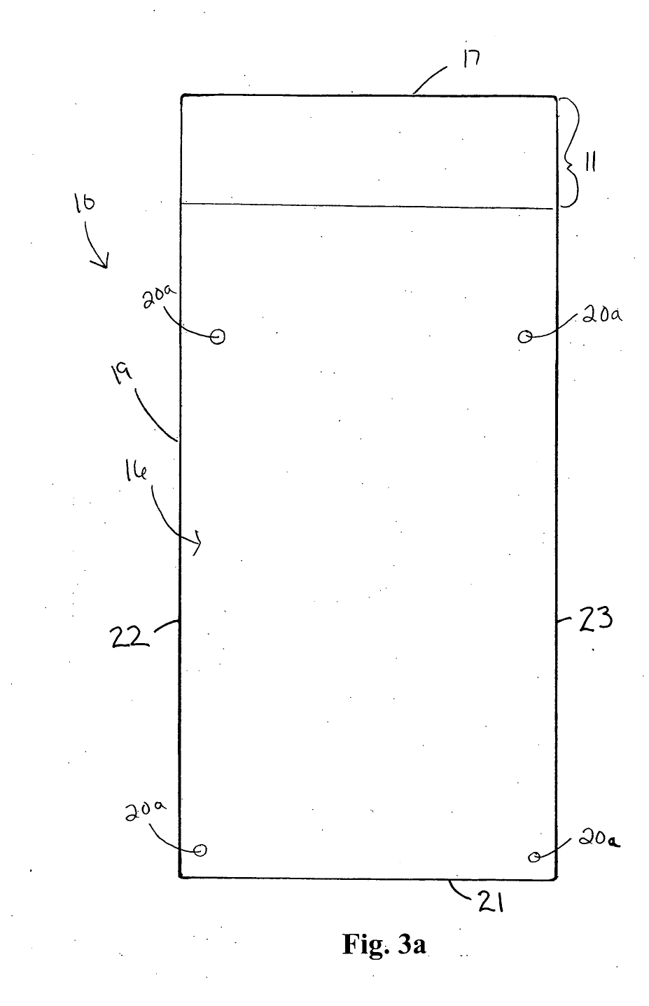

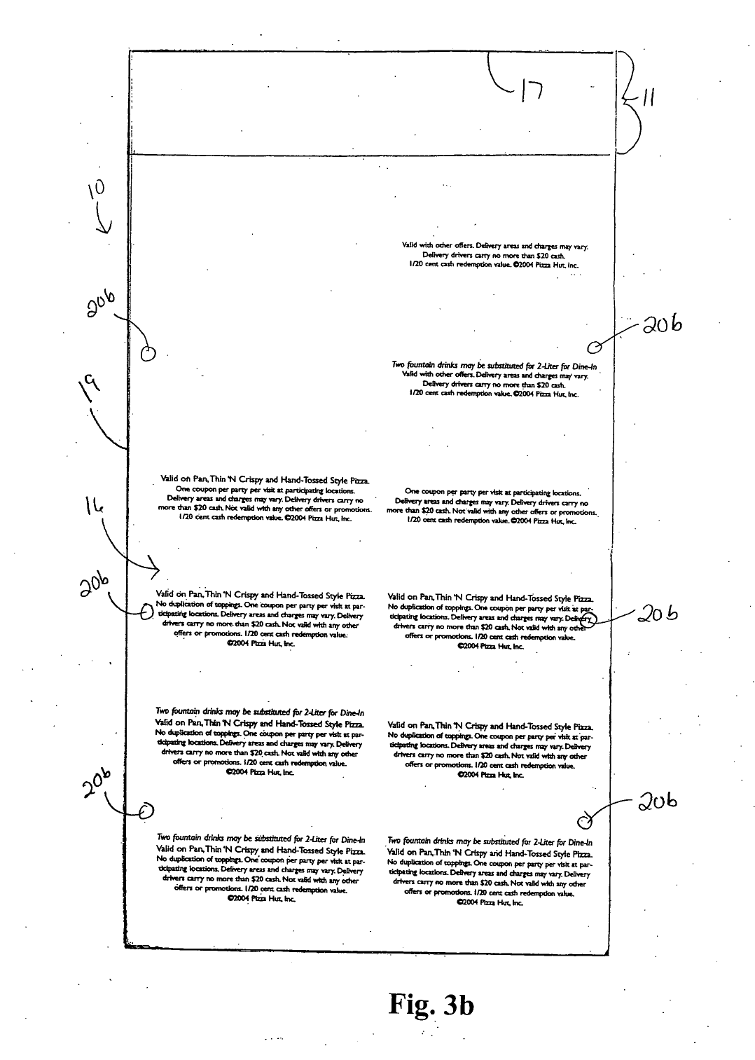

Two or more pages of the advertising piece 10 are adhered to each other via nonpermanent glue spots 20. The first page 15 and the second page 19 are adhered to each other at the second planar surface 14 and the third planar surface 16 via the glue spots 20. These glue spots 20 position multiple pages together so that the advertising piece 10 maintains its structural integrity as it moves through the USPS mailing process, while allowing for easy page separation by the recipient. As shown in FIG. 3a, the third planar surface 16 has four glue spots 20a. As shown in FIG. 3b, the third planar surface 16 has six glue spots 20b. Any number of glue spots 20 may be utilized so long as multiple pages remain adhered to each other and the structural integrity of the advertising piece 10 is maintained as it moves through the USPS mailing process. The first page 15 and the second page 19 can be separated from each other by pulling apart at these glue spots 20a, 20b to expose the interiorly located second planar surface 14 and the third planar surface 16. However, the first page 15 and the second page 19 may still remain attached at adhesion area 11 of the leading edge 17.

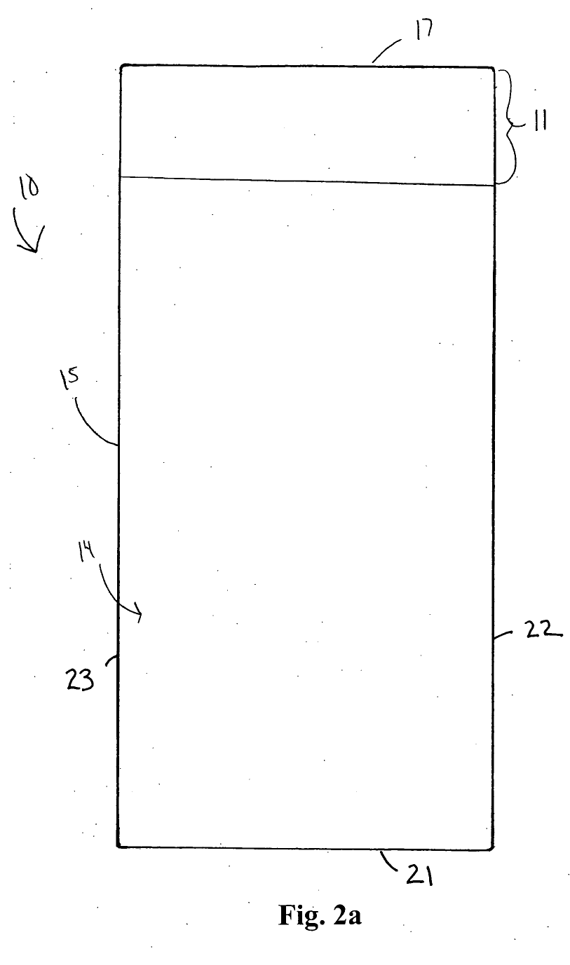

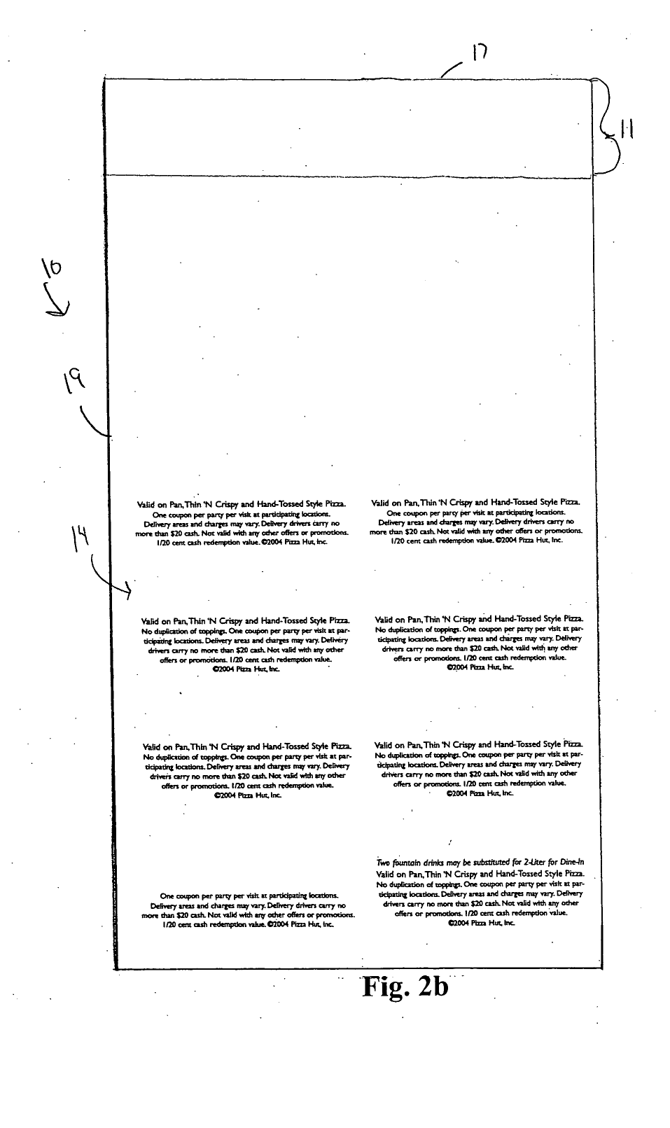

Referring now to FIGS. 1a and 1b, the first planar surface 12 of the first page 15 will most likely display information such as advertisements, contact information for the advertising company, and an assortment of coupons. Referring now to FIGS. 2a and 2b, the second planar surface 14 of the first page 15 will most likely display information such as coupon disclaimers, terms/conditions, and any other pertinent information that may not be aesthetically pleasing from an advertising standpoint. Due to the positioning of the second planar surface 14, such information is hidden from view until the first page 15 and the second page 19 are separated at the glue spots 20 by the recipient. Referring now to FIGS. 3a and 3b, the third planar surface 16 of the second page 19 will most likely display information such as coupon disclaimers, terms/conditions, and any other pertinent information that may not be aesthetically pleasing from an advertising standpoint. Like the second planar surface 14, the third planar surface 16 displays information that will be hidden from view until the first page 15 and the second page 19 are separated at the glue spots 20 by the recipient. Placing the non-aesthetically information in such a way allows for more surface area on the first planar surface 12 and the fourth planar surface 18 for aesthetically pleasing material, such as advertisements, coupons and trademarks. Referring now to FIGS. 4a and 4b, the fourth planar surface 18 of the second page 19 will display information including additional coupons, advertising, and mail address routing information. Also, a magnet or a repositionable adhesive with liner may be positioned on the fourth planar surface 18.

Due to the fact that the advertising piece 10 is comprised of multiple pages, advertisements and coupons are not required to be “back-to-back”, that is, perforations for coupons and the like do not have to be lined up, and can even be optional on either page. This allows for different layouts on each page of the advertising piece 10 and for different perforation possibilities (i.e., one section could be perforated into 10 coupons, while the other section could be perforated into 20 “smaller” coupons or not perforated at all). As shown, the coupons in FIGS. 1b and 4b have vertical and horizontal perforations separating the individual coupons.

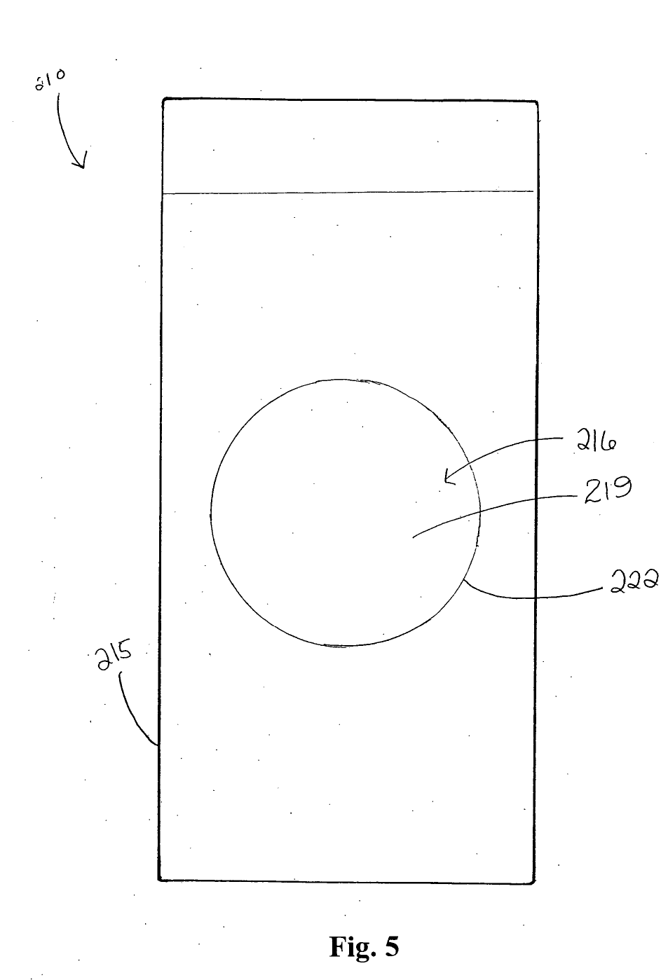

FIG. 5 illustrates another embodiment of the advertising piece 210. In this embodiment, a “die-cut” hole 222 is formed in the first page 215 to expose a portion of the third planar surface 216 of the second page 219. Any die cut shape can be formed in the first page 215 to expose the third planar surface 216, however, the second page 219 (“hidden” behind the first page 215 in FIG. 5 except for the die-cut hole 222) must remain “full size” and solid to contribute to the integrity of the advertising piece 210.

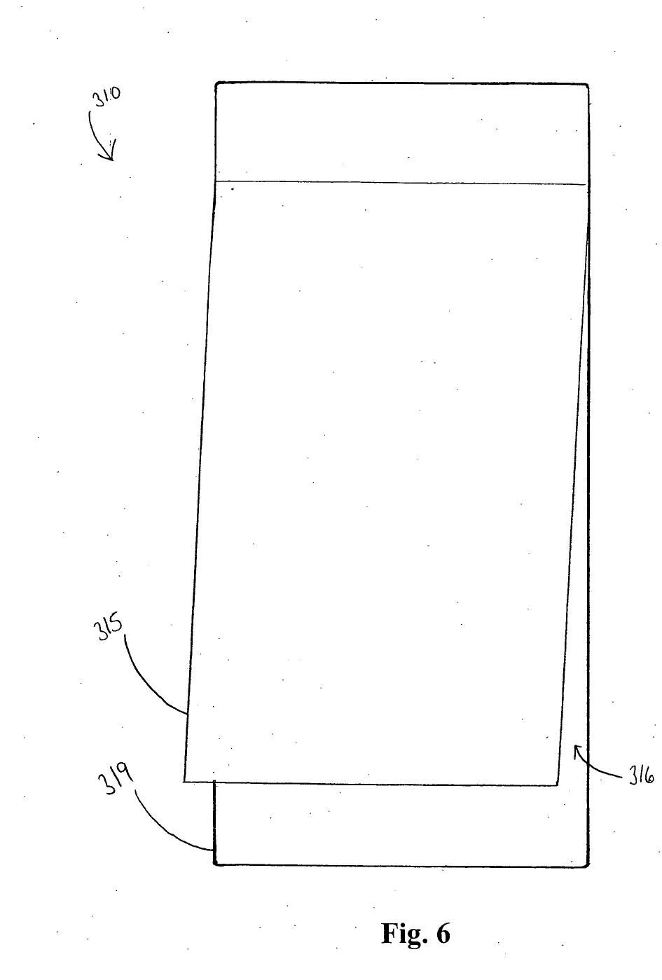

FIG. 6 illustrates yet another embodiment of the advertising piece 310. Here, in contrast to the embodiment of FIGS. 1-4 where the first and second pages were of same length, the first page 315 is shorter than the second page 319 to expose a greater surface area of the third planar surface 316 of the second page 319. The positioning of the glue spots (not shown in FIG. 6) on the third planar surface 316 must be adjusted accordingly due to the shortened length of the first page 315. Again, the second page 319 must remain “full size” and solid to contribute to the integrity of the advertising piece. For drawing convenience, the first page 315 is shown slightly raised from the second page 319 at its bottom edge.

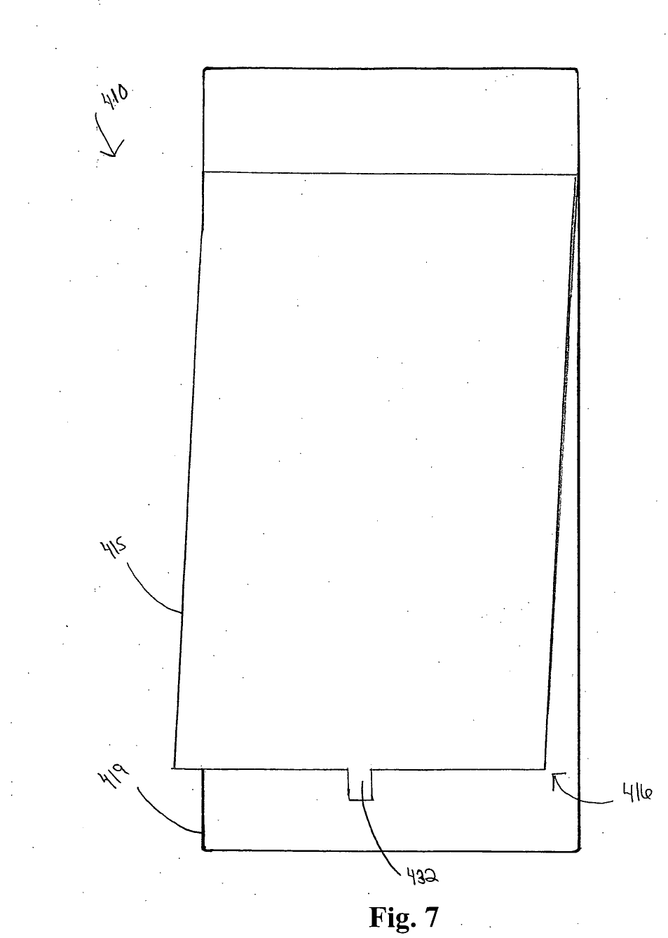

FIG. 7 illustrates still yet another embodiment of the advertising piece 410. Here, the first page 415 is shorter than the second page 419 to expose a greater surface area of the third planar surface 416 of the second page 419. A pull tab 432 (i.e., “lift” tab) positioned on the first page 415 allows for the user to easily grab the first page 415 and pull it away from the second page 419. The pull tab 432 may be of varying sizes and shapes and positioned at varying locations on the first page 415. Further, the first page 415 does not have to be shorter than the second page 419, and the pull tab 432 could optionally extend past the second page 419. Again, the second page 419 must remain “full size” and solid to contribute to the integrity of the advertising piece. For drawing convenience, the first page 415 is shown slightly raised from the second page 419 at its bottom edge.

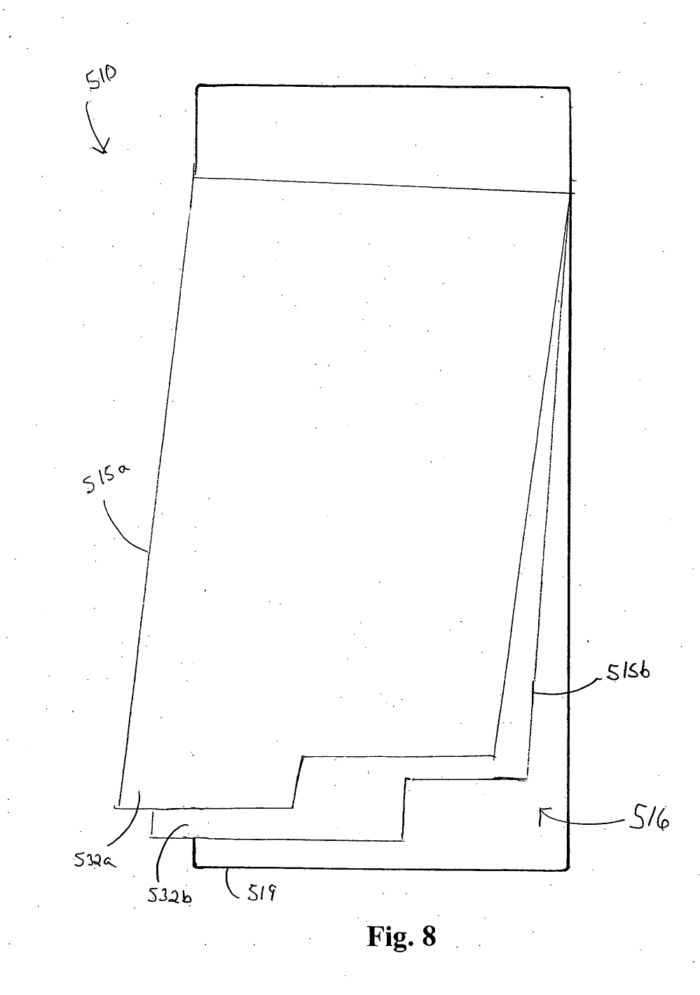

FIG. 8 illustrates yet another embodiment of the advertising piece 510. Here, there are multiple pages: a first page 515a and a middle page 515b. This is illustrative of the fact that the invention can have multiple pages. Here, the first page 515a and middle page 515b are the same size as the second page 519. To expose a portion of the third planar surface 516 of the second page 519, a tab 532b results after a lower portion of the middle page 515b is removed. To expose a portion of the middle page 515b and a portion of the third planar surface 516 of the second page 519, another tab 532a results after a lower portion of the first page 515a is removed. The tabs 532a and 532b can be of varying sizes and shapes, so long as a portion of the underlying page(s) are exposed. Again, the second page 519 must remain “full size” and solid to contribute to the integrity of the advertising piece. For drawing convenience, the first page 515a and the middle page 515 are shown slightly raised from the second page 519 at their bottom edge. With a single-ply postcard, 9-point stock is used. With the prior two-ply embodiments, two pages of about 4.5-point stock are preferably used. In this three-ply embodiment 510, preferably three pages of about 3-point stock are used to obtain the best postage rates. Any number of pages can be used to form the multi-ply piece of the present invention.

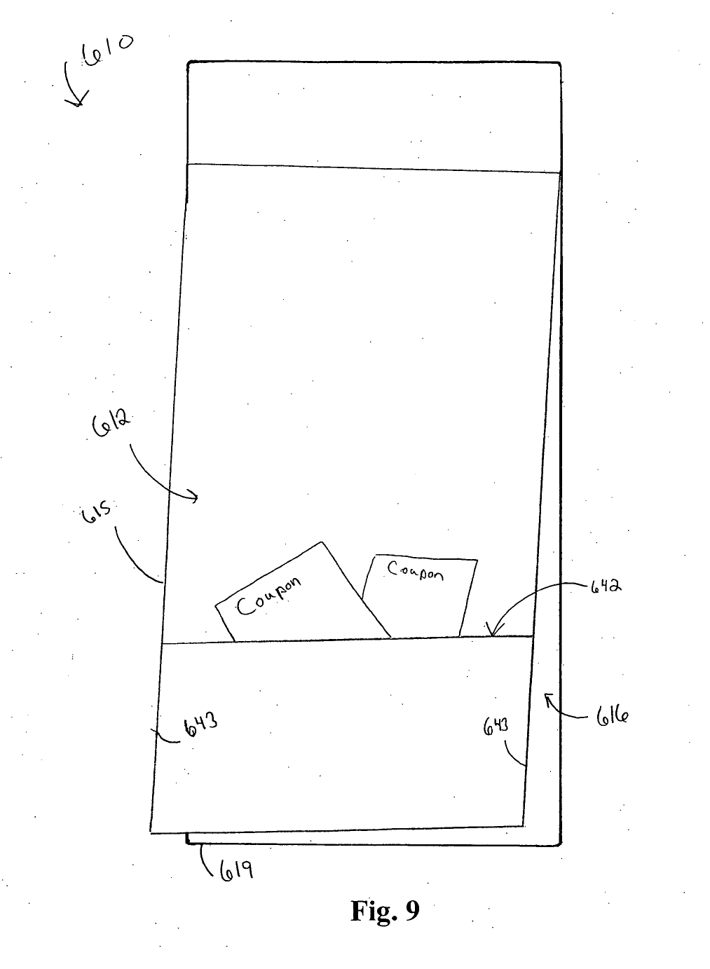

FIG. 9 illustrates still yet another embodiment of the advertising piece 610. Here, the first planar surface 612 of the first page 615 includes an outside pocket 642. The outside pocket 642 may be formed by the first page 615 being folded upon itself and permanently adhered at the edges 643 of the outside pocket 642, although other formations of the outside pocket 642 are within the scope of the invention. Again, the second page 619 must remain “full size” and solid to contribute to the integrity of the advertising piece 610. For drawing convenience, the first page 615 is shown slightly raised from the second page 619 at its bottom edge.

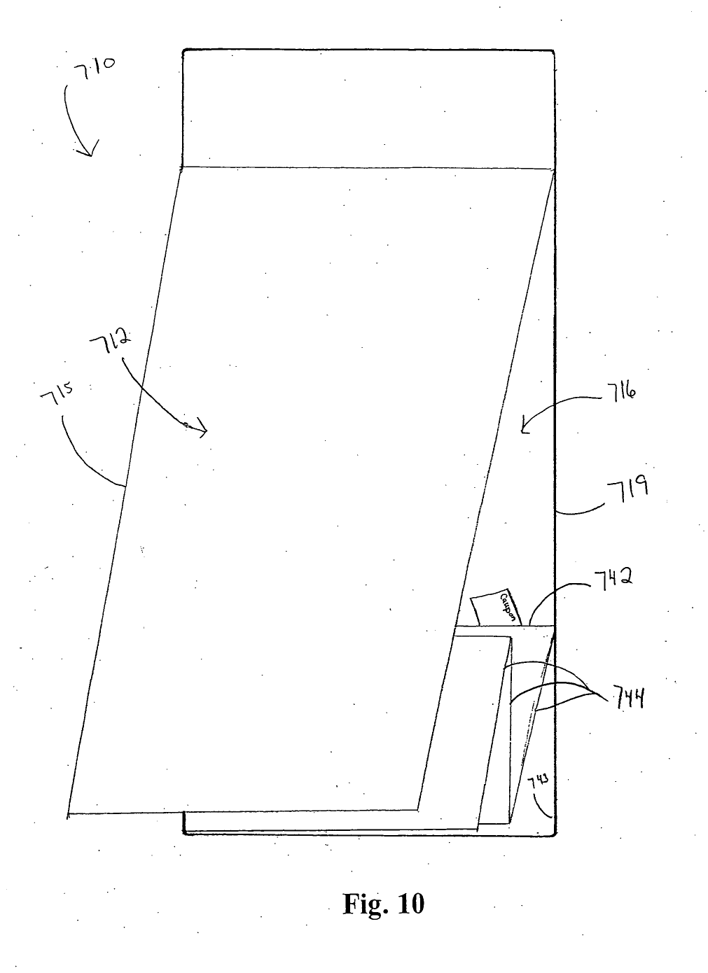

FIG. 10 illustrates yet another embodiment of the advertising piece 710. Here, the third planar surface 716 of the second page 719 includes an inside pocket 742. The inside pocket 742 may be formed by the second page 719 being folded upon itself and permanently adhered at the edges 743 of the inside pocket 742, although other formations of the inside pocket 742 are within the scope of the invention. Furthermore, an accordion fold 744 may be formed to provide more surface area for advertisements and coupons. This accordion fold portion 744 extends from the end of the portion of the second page 719 that forms the pocket inside 742. These advertisements and coupons can also be perforated for ease of separation, and then placed in the inside pocket 742. Note, it is contemplated that the outside pocket 642 may also display the accordion fold as shown in FIG. 10. Again, the second page 719 must remain “full size” and solid to contribute to the integrity of the advertising piece. For drawing convenience, the first page 715 is shown slightly raised from the second page 719 at its bottom edge.

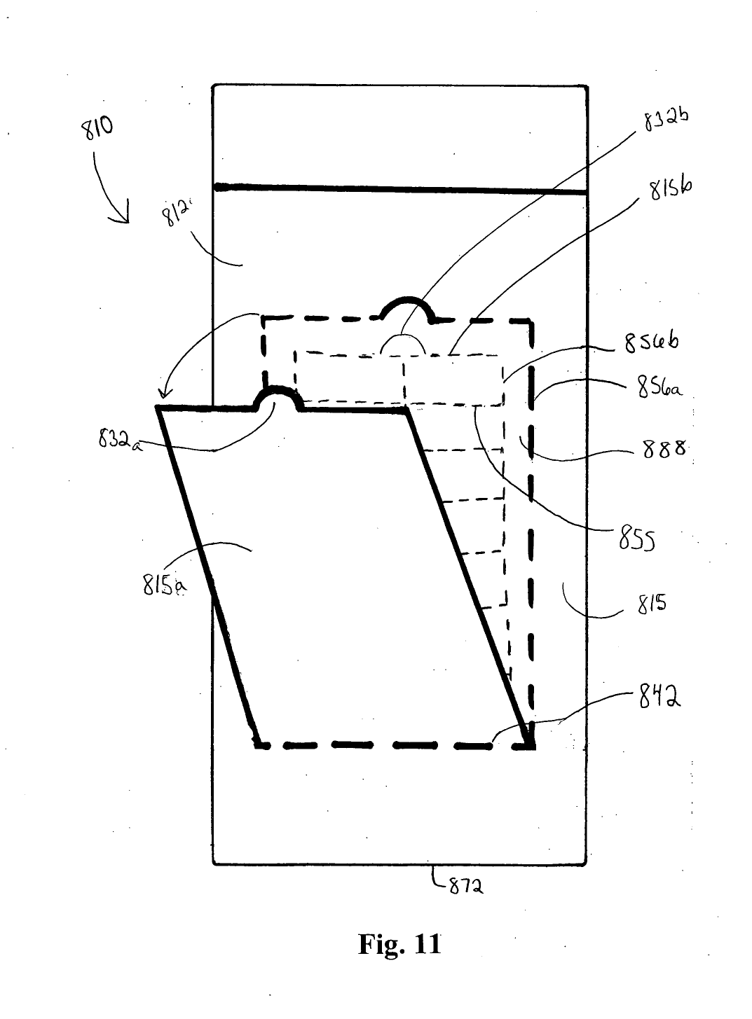

FIG. 11 illustrates yet another embodiment of the advertising piece 810. In this embodiment, perforations 856a formed in the first page 815 allow a first page cut-out 815a to be partially removed to expose part of a middle page 888. A tab 832a positioned on the first page cut-out 815a makes it easy for the recipient to separate the first page cut-out 815a from the first page 815. Upon separation, a series of coupons 855 or other advertisement material, which may be formed on the middle page 888, are positioned between the second planar surface (not shown) and the third planar surface 816 and may be exposed. Also, “loose” coupons or other advertising material may be positioned in the area between the second planar surface (not shown) and the third planar surface (not shown), particularly if no middle page 888 is present. Further, perforations 856b formed on the middle page 888 allow a middle cut-out 815b to be partially removed to expose the third planar surface of the second page. A menu or additional advertisements may be exposed on this third planar surface. The first planar surface 812 of the first page 815 may further include an outside pocket 842. For drawing convenience, the first page cut-out 815a is shown slightly torn from the perforations 856a to expose the middle page 888 and the coupons 855 or advertising material. This embodiment 810 shows a rectangular first page cut-out 815a, although any size or shape is within the scope of the invention, however, the second page 819 (“hidden” behind the first page 815 in FIG. 11) must remain “full size” and solid to contribute to the integrity of the advertising piece 810. Also note, one or more pages that are perforated and detachable are within the scope of this invention.

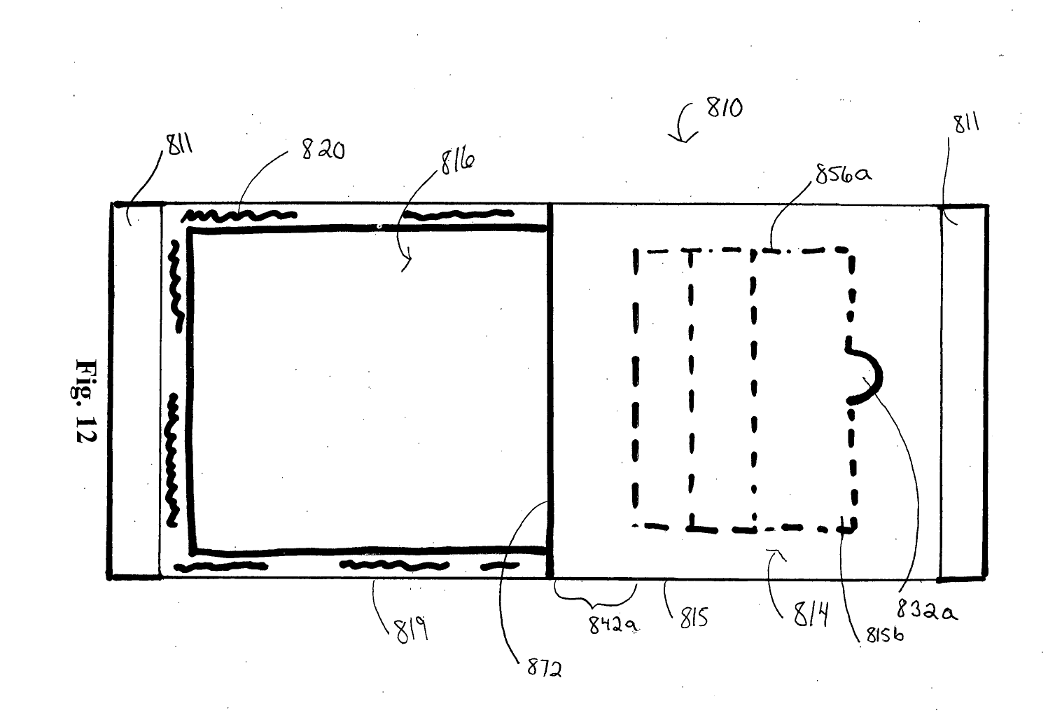

FIG. 12 illustrates the second planar surface 814 and the third planar surface 816 in an “open” and exposed position in the eighth embodiment of the invention 810. This illustration serves to highlight the interior construction of the advertising piece 810, and is not drawn to scale. The area to the left of the bottom fold line 872 or toward the bottom of the page when viewed in portrait orientation is the third planar surface 816 of the second page 819. Permanent glue areas 820, which vary in size, shape, and positioning, are located near the edge of the third planar surface 816. Permanent adhesion areas 811 are located near the ends of the second planar surface 814 and the third planar surface 816. The area to the right of the bottom fold line 872 or toward the top of the page when viewed in portrait orientation is the second planar surface 814 of the first page 815a, 815b. When the advertising piece 810 is folded at the bottom fold line 872, the third planar surface 816 and the second planar surface 814 are permanently adjoined at the glue areas 820 and the adhesion area 811. However, the first page cut-out 815b remains unattached to the third planar surface 816, and can be removed from the first 815a via the perforations 856 to expose the third planar surface 816. FIG. 12 also illustrates the backside 842a of the outside pocket 842.

Note, FIG. 12 does not show the middle page 888 for clearness. The middle page 888 may or may not be present in the eighth embodiment 810. However, if the middle page 888 were present in FIG. 12, it would line up against the glue areas 820 and be permanently attached at the glue areas 820. The middle page 888 would also have a similarly-aligned glue area 820 so that when the first page 815 folds at the bottom fold line 872, the second planar surface 814 would fold to meet the middle page 888 and be permanently attached at the glue areas.

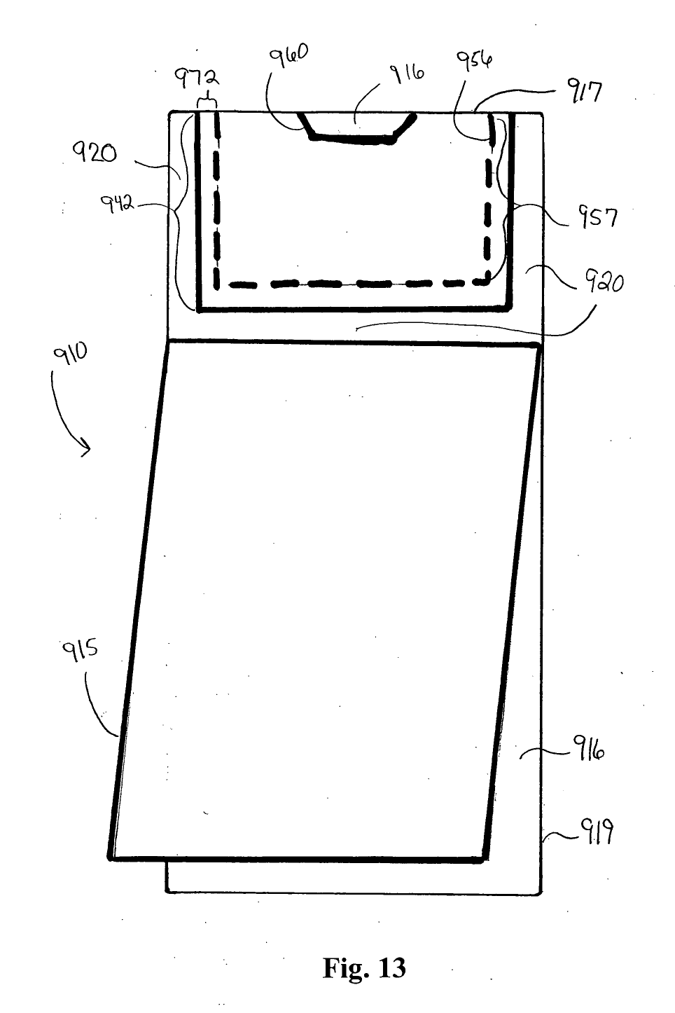

FIG. 13 illustrates a ninth embodiment of advertising piece 910. Here, the first page 915 is shown slightly raised from the second page 919 at its bottom edge for drawing convenience. The positioning of the nonpermanent glue spots (not shown in FIG. 13) on the third planar surface 916 must be adjusted accordingly due to the top pocket insert 942 positioned near the lead edge 917 of the advertising piece. The top pocket insert 942 is formed by a permanent glue line area 920 which affixes the second planar surface (not shown) and the third planar surface 916. The glue line area 920 runs along the edge of the top pocket insert 942 and at the sides, but does not run completely along the lead edge 917, to form the top pocket insert 942. Again, the second page 919 must remain “full size” and solid to contribute to the integrity of the advertising piece 910.

Optionally, in the ninth embodiment of the advertising piece 910, the pocket insert 942 may include a die-cut notch 960 which would expose a small portion of the third planar surface 916. This optional notch 960 may be of any size and positioned anywhere along the leading edge 917 except at the glue line area 920. The notch 960 facilitates the grasping of any materials that may be positioned in the top pocket insert 942. Nonpermanent glue spots (not shown) could then be positioned on either side of the notch 960, so that when the recipient wants to place something inside the top pocket insert 942, he must separate the second planar surface (not shown) from the third planar surface 916. Alternatively, the notch 960 may be positioned on the second page (only the third planar surface 916 of the second page is shown), such that it would not be visible when the advertising piece 910 is hung from a refrigerator or other surface. Again, nonpermanent glue spots could then be positioned on either side of the notch.

Optionally, in the ninth embodiment of the advertising piece 910, the pocket insert 942 may further include a removable area 957 formed by perforations 956. This removable area 957 may include one or more coupons, or perhaps a game schedule, or perhaps a “loyalty” card for future use. Detaching the removable area 957 may expose more area of the third planar surface 916, which may include menu information or more advertisements. Once the removable area 957 is detached from the remaining portion of the top pocket insert 942, a frame 972 remains. This frame 972 is still attached to the top pocket insert 942, but is not attached to the third planar surface 916 of the second page via glue. The recipient could display an object, such as a picture for example, in the frame 972. The advertising piece 910 could then be mounted to a refrigerator via the magnet (not shown) and display information such as coupons which can be torn off, and even a picture inserted into the frame 972.

The foregoing detailed description is given primarily for clearness of understanding and no unnecessary limitations are to be understood therefrom for modifications can be made by those skilled in the art upon reading this disclosure and may be made without departing from the spirit of the invention and scope of the appended claims.

What is claimed is:

1. A multi-ply advertising piece, comprising:
a. a first page having a first planar surface and a second planar surface;
b. a second page having a third planar surface and a fourth planar surface;
c. said second planar surface and said third planar surface having a first glue located in a permanent adhesion area proximate a leading edge of the advertising piece, the advertising piece having an opposite edge and a left side and a right side;
d. means for attachment affixed to said fourth planar surface at a location near said leading edge; and,
e. a second glue located between said second planar surface and said third planar surface along said left side and said right side of the advertising piece.

2. The multi-ply advertising piece of claim 1, where said means for attachment is magnetic.

3. The multi-ply advertising piece of claim 1, where said means for attachment comprises a repositional adhesive having a removable liner thereover.

4. The multi-ply advertising piece of claim 1, where the first glue in said permanent adhesion area runs from said leading edge toward said opposite edge and from said left side to said right side along said leading edge.

5. The multi-ply advertising piece of claim 1, where the second glue comprises a plurality of glue spots.

6. The multi-ply advertising piece of claim 1, where said first page and said second page have a combined thickness of at least 9 point.

7. The multi-ply advertising piece of claim 1, where said piece includes a plurality of removable coupons, where said piece includes advertiser contact information on said first planar surface, and where said piece includes mail address information on said fourth planar surface.

8. The multi-ply advertising piece of claim 1, where said first page has a first page length and where said second page has a second page length, said first page length being the same as said second page length.

9. The multi-ply advertising piece of claim 1, where said first page includes a hole therethrough to expose a portion of said third planar surface.

10. The multi-ply advertising piece of claim 1, where said first page has a first page length and where said second page has a second page length, said first page length being less than said second page length.

11. The multi-ply advertising piece of claim 1, where said first page includes a pull tab toward said opposite edge of said piece.

12. The multi-ply advertising piece of claim 1, where a middle page is inserted between said first page and said second page.

13. The multi-ply advertising piece of claim 12, where said first page includes a first page pull tab toward said opposite edge of said piece and said middle page includes a middle page pull tab toward said opposite edge of said piece.

14. The multi-ply advertising piece of claim 1, where said first page includes a pocket toward said opposite edge of said piece, said pocket formed by folding a portion of said first page onto said first page and adhering along said left side and said right side.

15. The multi-ply advertising piece of claim 1, where said second page includes a pocket toward said opposite edge of said piece, said pocket formed by folding a portion of said second page onto said second page and adhering along said left side and said right side.

16. The multi-ply advertising piece of claim 15, where said pocket has a plurality of accordion folded portions attached thereto.

17. The multi-ply advertising piece of claim 1, where the second glue comprises permanent glue areas along said left side and along said right side, and an additional glue line along said opposite edge, said first page having a first page cut out which is at least partially removable.

18. The multi-ply advertising piece of claim 1, where the first glue in said permanent adhesive area runs from said leading edge along said left side and along said right side partways toward said opposite edge and from said left side to said right side at a location distant from said leading edge thereby forming a pocket between said first page and said second page along a portion of said leading edge.

19. A multi-ply advertising piece, comprising:
a. a first page having a first planar surface and a second planar surface;
b. a second page having a third planar surface and a fourth planar surface;
c. said second planar surface and said third planar surface having a first glue located in a permanent adhesion area proximate a leading edge of the advertising piece, the advertising piece having an opposite edge and a left side and a right side;
d. a magnet affixed to said fourth planar surface at a location near said leading edge; and,
e. a second glue located between said second planar surface and said third planar surface along said left side and said right side of the advertising piece.

20. The multi-ply advertising piece of claim 19, where the first glue in said permanent adhesion area runs from said leading edge toward said opposite edge and from said left side to said right side along said leading edge.

21. The multi-ply advertising piece of claim 19, where the second glue comprises a plurality of glue spots.

22. The multi-ply advertising piece of claim 19, where said first page and said second page have a combined thickness of at least 9 point.

23. The multi-ply advertising piece of claim 19, where said piece includes a plurality of removable coupons, where said piece includes advertiser contact information on said first planar surface, and where said piece includes mail address information on said fourth planar surface.

24. A multi-ply advertising piece, comprising:
a. a first page having a first planar surface and a second planar surface;
b. a second page having a third planar surface and a fourth planar surface;
c. said second planar surface and said third planar surface having a first glue located in a permanent adhesion area proximate a leading edge of the advertising piece, the advertising piece having an opposite edge and a left side and a right side;
d. a repositionable adhesive having a removable liner thereover affixed to said fourth planar surface at a location near said leading edge; and,
e. a second glue located between said second planar surface and said third planar surface along said left side and said right side of the advertising piece.
